(19) United States
(12) Patent Application Publication
(10) Pub. No.: US 2007/0180143 A1
(43) Pub. Date: Aug. 2, 2007

(54) Translation Web Services For Localizing Resources

(75) Inventor: Esaias E Greeff, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,804

(22) Filed: Jan. 30, 2006

(51) Int. Cl. G06F 15/16

(52) U.S. Cl. 709/246

(57) ABSTRACT

Translation web services for localizing resources include a server receiving language-independent messages containing localizable resource elements. A client receives the messages from the server, and requests a localized version of the resource element in a specified human-understandable language. A translation web service receives the request, and provides a localized version of the localizable resource element in the specified language.

### BACKGROUND

Computer networks increasingly include users who may speak a variety of different languages. As events occur within the computer networks, messages reporting these events may be provided to the users in textual form, for example, via alert boxes, or the like. Messages or event notifications that may be provided to users in native languages may be referred to as localizable resources, and the process of providing these messages or event notifications to the users in their native languages may be referred to as localizing the resources.

In a large network having a variety of users speaking disparate languages, it becomes a challenge to localize these resources for reporting in the various languages preferred by the different users. One approach to addressing this challenge is to include within the resource multiple versions of a message, localized into different languages. This approach expands the size and overhead of the reported resources. Moreover, this approach becomes especially inefficient when one recognizes that not all resources need be reported to users.

Additionally, in a client-server deployment, the population of clients may be changing constantly, along with the population of preferred languages preferred by such clients or users. In such an environment, it becomes difficult to keep the clients and the servers synchronized, such that the servers know the languages preferred by a current group of clients, and so that the clients know what languages are supported by the servers.

### SUMMARY

Systems, methods, and/or techniques (“tools”) for providing translation web services for localizing resources are described herein. The tools can include a server receiving language-independent messages containing localizable resource elements. A client receives the messages from the server, and requests a localized version of the resource element in a specified human-understandable language. A translation web service receives the request, and provides a localized version of the localizable resource element in the specified language.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTIONS OF THE DRAWINGS

Tools for providing translation web services for localizing resources are described in connection with the following drawing figures. The same numbers are used throughout the disclosure and figures to reference like components and features. The first digit in a reference number indicates the drawing figure in which that reference number is introduced.

FIG. 1 is a block diagram of an operating environment suitable for providing a translation web service for localizing resources.

FIG. 2 is a diagram illustrating example message flows by which a client and/or a translation request component may obtain representations of localizable resource elements that are supported by a translation web service.

FIG. 3 is a diagram illustrating example message flows by which the client and/or the translation request component may request a list of languages supported by the translation web service.

FIG. 4 is a diagram illustrating example message flows by which the client and/or the translation request component may retrieve a formatted localized resource corresponding to a received resource element.

FIG. 5 is a diagram illustrating example message flows by which the client and/or the translation request component may retrieve an unformatted localized resource corresponding to the received resource element.

FIG. 6 is a diagram illustrating a process flow and related components by which the client may obtain formatted versions of localized resources.

FIG. 7 is a diagram illustrating a process flow and related components by which the client may obtain unformatted versions of localized resources.

### DETAILED DESCRIPTION

Overview

The following document describes tools capable of many techniques and processes. The following discussion describes exemplary ways in which the tools provide a translation web service for localizing resources. This discussion also describes other techniques performed by the tools.

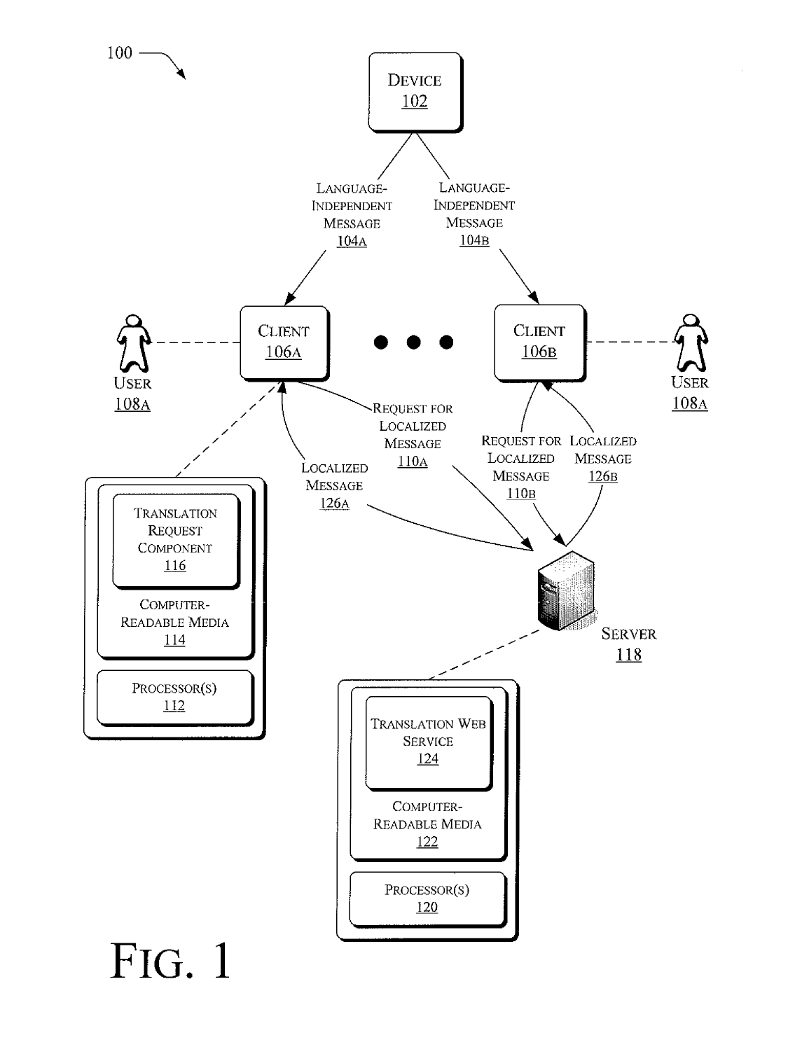

For convenience only, but not limitation, this document is organized into sections, with the sections introduced by corresponding headings. First, Operating Environments are described in connection with FIG. 1. FIG. 1 illustrates operating environments related to providing a translation web service for localizing resources, and also provides illustrative data flows.

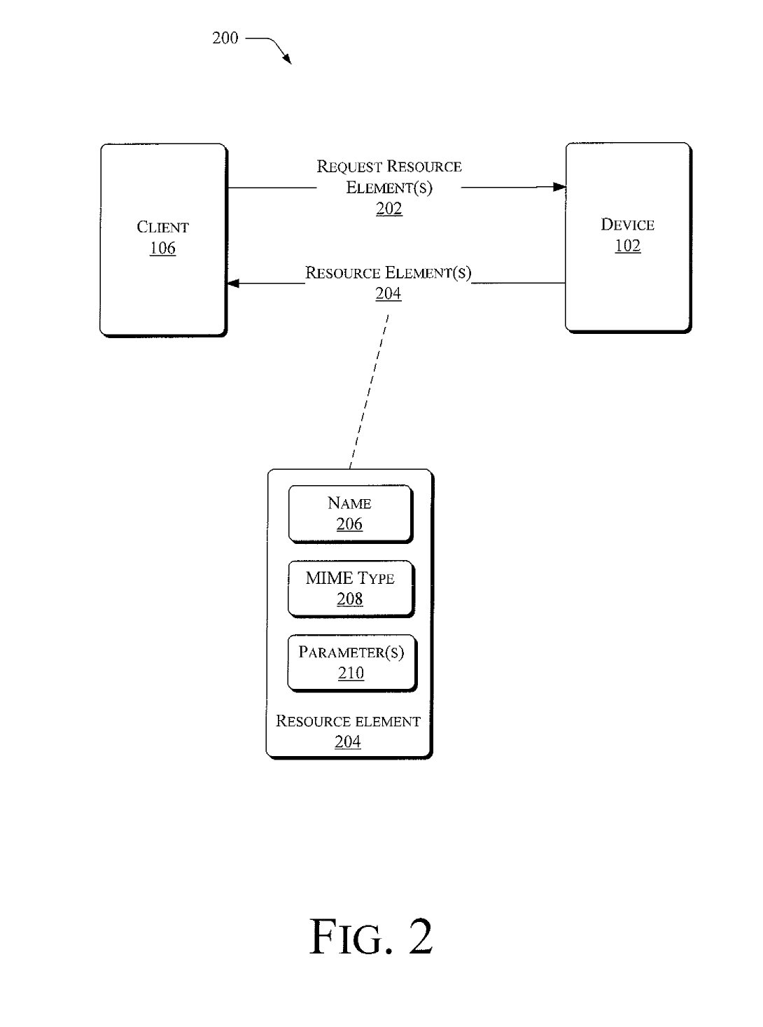

Next, Message Flows, Data Structures, and Schemas are described in connection with FIGS. 2-5. FIGS. 2-5 illustrate examples of various schemas for requests related to a translation web service for localizing resources, and responses to such requests.

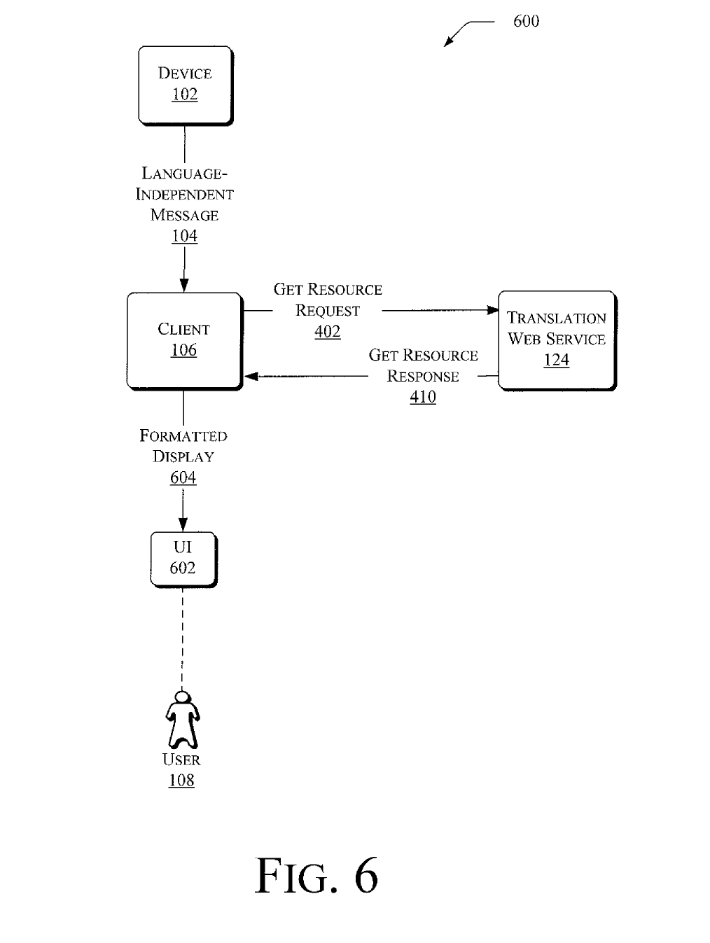

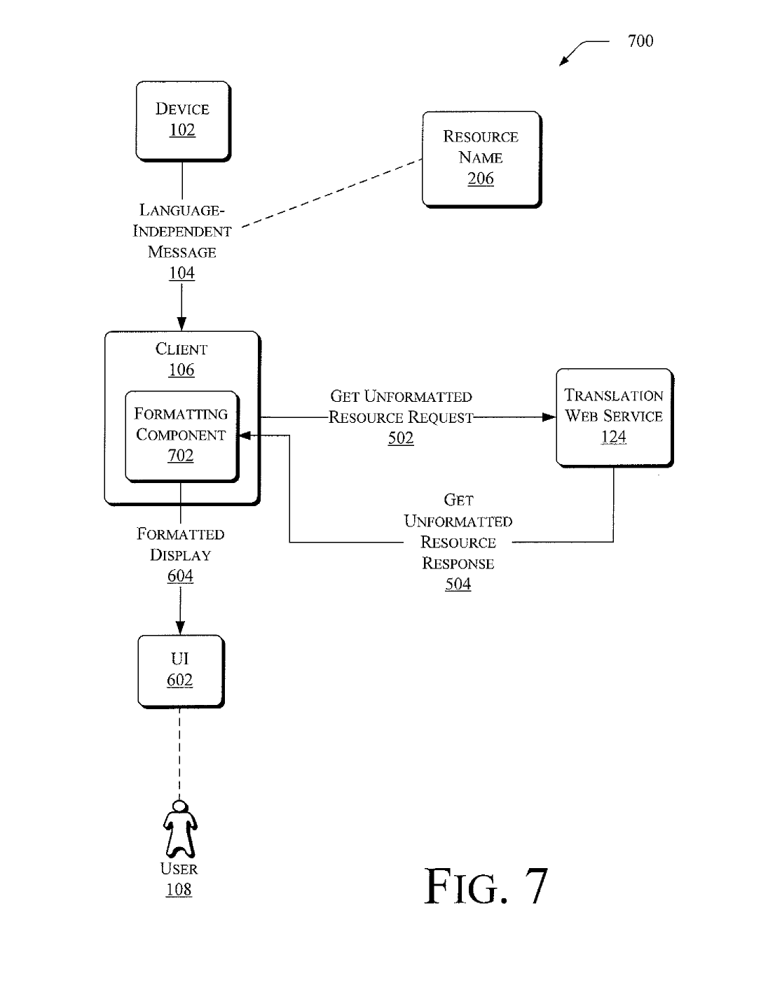

Finally, Process Flows and Protocols are described in connection with FIGS. 6-7. FIGS. 6-7 illustrate example process flows and protocols for a translation web service for localizing resources.

Operating Environments

FIG. 1 illustrates an operating environment 100 suitable for providing a translation web service for localizing resources. The term “localize” refers to providing content in a given human-understandable language that is chosen for a given user. Content can include text messages, images with accompanying text, audio data, video data, or the like.

The operating environment 100 may include one or more devices 102. FIG. 1 shows one representative device 102 only for convenience of illustration, but not to limit possible implementations of the operating environment 100. A non-limiting example of the device 102 may be a printer or other peripheral. However, the device 102 may take the form of any suitable service or resource capable of generating messages 104. In general, the device 102 may take the form of any computer-based device running software that includes any localizable content, or produces messages 104 that include such content.

The messages 104 from the device 102 may be independent of any human language, and may be understandable to machines or computing devices. Returning to the printer example introduced above, the messages 104 may report various events or states of the device 102, such as the printer being out of paper, being jammed at some location, or having some number of sheets remaining in its input tray.

The messages 104 may be received at one or more clients 106. FIG. 1 shows two representative clients 106a and 106b only for convenience of illustration, but not to limit possible implementations of the operating environment 100. For convenience, the message 104 as received at the client 106a is referenced as message 104a, and the message 104 as received at the client 106b is referenced as message 104b.

In general, the operating environment 100 may include one or more clients 106. The clients 106 may take the form of any computer-based device that receives messages 104, and may request that at least portions of the messages 104 be localized.

The clients 106a and 106b may be associated with respective users 108a and 108b. The users 108a and 108b may have particular language preferences for any human-readable messages presented to them. Assume, for example, that the user 108a speaks American English, and that the user 108b speaks French. In this example, the client 106a may request that the message 104a be localized into American English. This request for localization from the client 106a is referenced as request 110a. Likewise, the client 106b may request that the message 104b be localized into French. This request for localization from the client 106b is referenced as request 110b.

The clients 106 may include one or more processor(s) 112 and computer-readable media 114. The computer-readable media 114 may contain instructions that, when executed by the processor 112, perform any of the tools described herein. The processor 112 may be configured to access and/or execute the instructions embedded or encoded onto the computer-readable media 114. The processor 112 may also be categorized or characterized as having a given architecture.

The computer-readable media 114 may also include a translation request component 116. The translation request component 116 may be implemented as a module, program, or other entity capable of interacting directly or indirectly with one or more entities external to the client 106. Illustrative functions and capabilities of the translation request component 116 are detailed below in connection with describing the tools.

For clarity and convenience of illustration only, FIG. 1 shows the processor 112, computer-readable media 114, and translation request component 116 as associated with the client 106a. However, it is understood that other clients 106 (e.g., the client 106b) may also be associated with respective instances of the processor 112, the computer-readable media 114, and the translation request component 116.

The translation request component 116 may formulate the requests 110, and may present the requests 110 to a server 118. The server 118 may comprise a computing device, such as a network or other server, a desktop computer, a laptop or notebook computer, or any other computing device configured to perform the functions described herein in connection with the server 118.

The server 118 may include one or more processor(s) 120 and computer-readable media 122. The computer-readable media 122 may contain instructions that, when executed by the processor 120, perform any of the tools described herein. The processor 120 may be configured to access and/or execute the instructions embedded or encoded onto the computer-readable media 122. The processor 120 may also be categorized or characterized as having a given architecture.

The computer-readable media 122 may also include a translation web service 124. The translation web service 124 may be implemented as a module, program, or other entity capable of interacting directly or indirectly with one or more entities external to the server 118. Illustrative functions and capabilities of the translation web service 124 are detailed below in connection with describing the tools.

In overview, the translation web service 124 provides a mechanism for receiving requests 110 from the clients 106. The translation web service 124 localizes resources, such as the messages 104, in response to these requests 110. The responses to the requests 110 are referenced in FIG. 1 as localized messages 126a and 126b, which are provided to the clients 106.

It is understood that the description herein uses the terms “translation request component” and “translation web service” only for convenience, but not for limitation. It is further understood that implementations of the operating environment 100 may include components having similar functionality, but having different names or labels.

For convenience only, the translation web service 124 is shown in FIG. 1 in connection with the server 118. However, it is understood that the translation web service 124 could be provided in connection with components other than the server 118 without departing from the scope and spirit of the subject matter described herein. For example, the translation web service 124 may be configured as a third-party service made available to a variety of different clients 106 and servers 118. It is also noted that in some implementations, the server 118 and the device 102 may reside on the same machine. In these latter implementations, the device 102 may host its own translation web service 124.

Message Flows, Data Structures, and Schemas

Having described the operating environment 100 in FIG. 1, the discussion turns to a description of various data structures and schemas that may be employed by the various components of the operating environment 100. This description begins by discussing in more detail several illustrative messages that may be passed between the translation request component 116 (and/or the client 106) and the translation web service 124 (and/or the server 118). More particularly, these example messages may take the form of the requests 110 from the translation request component 116, and the responses 126 thereto from the translation web service 124.

FIG. 2 illustrates an example message flow 200 by which the client 106 and/or the translation request component 116 may obtain representations of localizable resource elements, such as the messages 104, that are supported by the device 102. In but one possible implementation, the client 106 may provide a request 202 for the resource elements, and the device 102 may respond with representations of one or more resource elements 204.

FIG. 2 shows an illustrative data structure for representations of the resource elements 204. The clients 106 may refer to these representations of the resource element 204 when processing the messages 104, for example.

A field 206 may contain data representing a name of the resource element 204. For example, the field 206 may contain a string representing a unique, language-independent identifier for the resource element 204.

A field 208 may contain data representing a type of the resource element 204. For example, the field 208 may contain data indicating a Multipurpose Internet Mail Extensions (MIME) type for the resource element 204.

A field 210 may contain parameters relevant to localizing the given resource element 204. In some instances of the resource element 204, the parameter field 210 may not be populated.

The following provides an example of an XML schema for the resource element 204. This description uses the following syntax to define normative outlines for messages. The syntax appears as an XML instance, and values in italics indicate data types instead of values. Characters are appended to elements and attributes to indicate cardinality, as follows:
“?” (0 or 1)
“*” (0 or more)
“+” (1 or more)
The character “|” is used to indicate a choice between alternatives.
The characters “[” and “]” are used to indicate that contained items are to be treated as a group with respect to cardinality or choice.

Ellipses (i.e., “. . . ”) indicate a point of extensibility that allows other child or attribute content. Additional children and/or attributes MAY be added at the indicated extension points.

The element 204 represents localizable resources that may appear in the messages 104:

[<tws:Resource Name=xs:string MimeType=xs:string>

[<tws:Param>xs:any</tws Param>]*

<tws:Resource>]+

Returning to the printer example described above, an example of a resource element 204 may be a particular error message issued by the device 102.

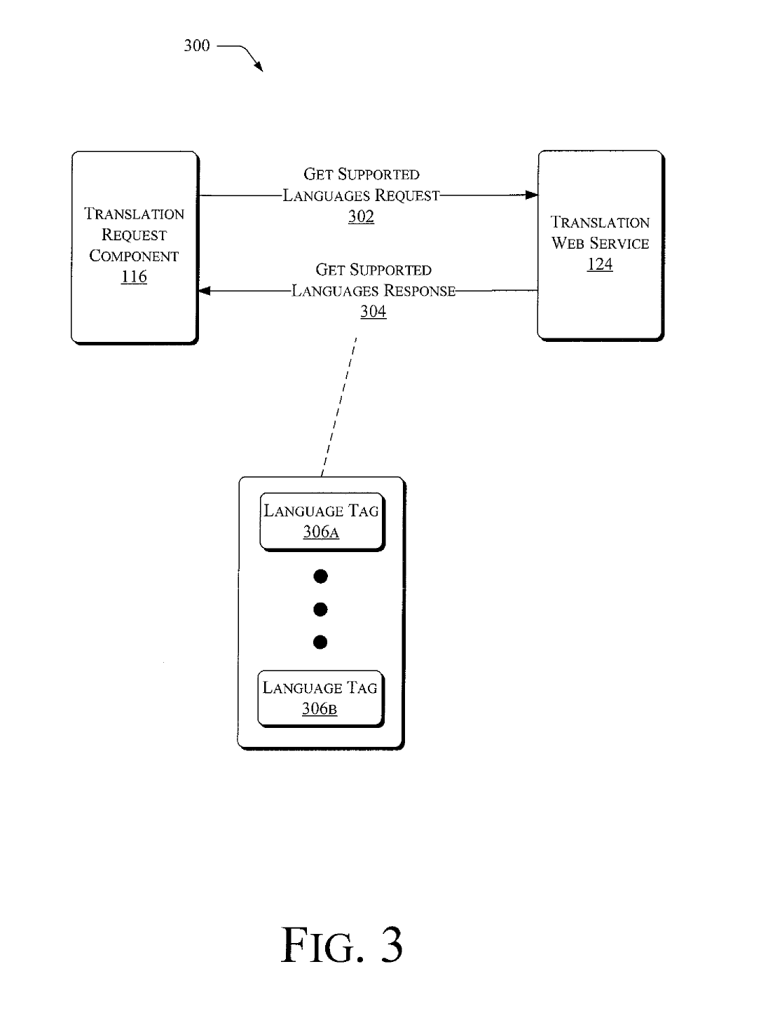

FIG. 3 illustrates an example message flow 300 by which the client 106 and/or the translation request component 116 may request a list of languages supported by the translation web service 124. For example, the translation request component 116 may submit a “get supported languages” request 302, and receive a “get supported languages response” 304 in reply thereto.

FIG. 3 also illustrates an example data structure for the response 304. As shown, the response 304 may contain one or more fields 306 for containing respective strings or tags corresponding to the various human-understandable languages supported by the translation web service 124. In but one possible implementation, these strings or tags may be compliant with RFC No. 3066. In any event, FIG. 3 shows two representative fields 306a and 306b only for convenience of illustration, but not to limit possible implementations.

The following provides an example of an XML implementation of the response 304:

<tws:GetSupportedLanguagesResponse>

<tws:SupportedLanguages>

List of xs:string

</tws:SupportedWebServices>

</tws:GetSupportedLanguagesResponse>

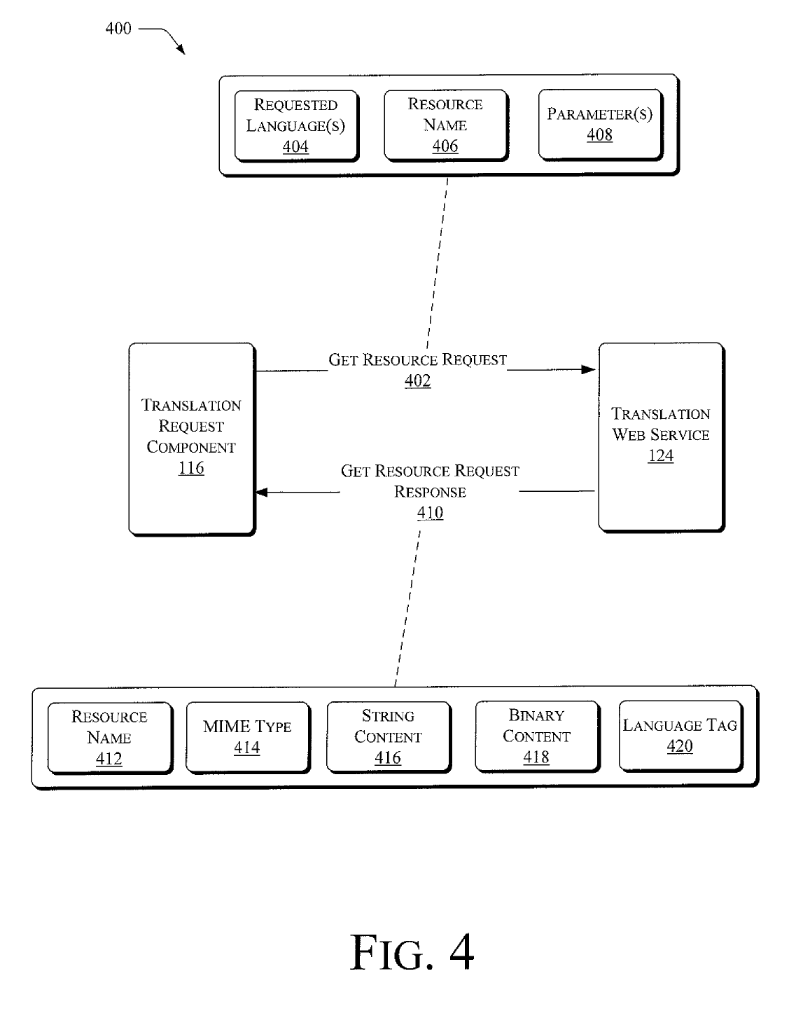

FIG. 4 illustrates an example message flow 400 by which the client 106 and/or the translation request component 116 may retrieve a localized resource corresponding to a received resource element 204. For example, having received a resource element 204, such as the message 104, the client 106 may request a localized representation or version of this resource element 204.

Returning to the printer example above, the resource element 204 may be contained in an error message 104 from the printer. If the client 106 determines to present the error message to the user 108, the client 106 can request (402) a localized resource corresponding to the received resource element 204. This request 402 is labeled herein, only for convenience, as a “get resource request”.

FIG. 4 also shows an illustrative data structure for the request 402. A field 404 may contain data representing a language in which the localized version of the resource element 204 is requested. Recall that the clients 106 may obtain a list of tags 306 for the languages supported by the translation web service 124, as discussed with FIG. 3 above. Thus, the language field 404 may contain one or more such tags 306. If the language field 404 is left blank or empty, this may imply that the client 106 is requesting versions of the resource element 204 in all languages supported by the translation web service 124.

A field 406 may contain data representing a language-independent identifier for the resource element 204. Recall from FIG. 2 above that the field 206 may contain such a language-independent identifier. Thus, when an instance of the resource element 204 is received by the client 106, the translation request component 116 may extract the contents of the field 206, and populate the field 406 of the request 402 therewith.

A field 408 may contain data representing one or more parameters for the received resource element 204. Recall from FIG. 2 above that the field 210 may contain one or more such parameters. Thus, when an instance of the resource element 204 is received by the client 106, the translation request component 116 may extract the contents of the field 210 (if any), and populate the field 408 of the request 402 therewith. Some implementations may preserve the order in which the parameters are expressed, when transferring the parameters from the received resource element 204 to the request 402.

The following provides an example of an XML implementation of the request 402:

<tws:GetResourceRequest>

[<tws:RequestedLanguages>

List of xs:string

</tws:RequestedLanguages>

<tws:RequestedResources>

[<tws:Resource Name=xs:string>

[<tws:Param>xs:string</tws:Param>]*

<tws:Resource>]+

</tws:RequestedResources>

</tws:GetResourceRequest>

The translation web service 124 may receive and process the request 402, and provide a response 410 thereto. The response 410 includes a localized version or representation of the resource element 204 received by the client 106. For example, the response 410 may be used to form the localized messages 126 shown in FIG. 1.

FIG. 4 also provides an illustrative data structure for the response 410. Note that the response 410 may contain an instance of the localized resource for each language specified in the request 402, assuming that all of the requested languages are supported by the translation web service 124.

Illustrative fields of this structure are now described. A field 412 may contain data representing a language-independent identifier for the resource element 204, and may be populated from the field 406 of the request 402.

A field 414 may contain data representing a type for the resource element 204. For example, the field 414 may indicate a MIME type for the resource element 204. Recall from FIG. 2 above that the field 208 may contain data representing a type (e.g., a MIME type) for the given resource element 204.

A field 416 may contain a string representing the localized version of the resource element 204. A field 418 may contain a binary representation of the localized version of the resource element 204. A field 420 may contain a language tag indicating the human-understandable language in which the localized version of the resource element 204 is provided. Recall that language tags are discussed above in connection with the fields 306 in FIG. 3.

The following provides an example of an XML implementation of the response 410:

<tws:GetResourceResponse>

[<tws:LocalizedResource Name=xs:string MimeType=xs:string >

[<tws:Content xml:Lang=xs:string>

[

<tws:StringContent>xs:string</
tws:StringContent>

|

<tws:BinaryContent>xs:base64Binary</
tws:BinaryContent>

]

</tws:Content>]+

</tws:LocalizedResource>]+

</tws:GetResourceResponse>

It is noted that in the message flow 400 shown in FIG. 4, the translation web service 124 formats the response 410 on behalf of the client 106, using parameters 408 included in the request 402. In the message flow 400, the client 106 may contact the translation web service 124 each time it wishes to obtain a localized resource. In some instances, for example, this mechanism may result in the client 106 requesting the entire localized resource, when only one parameter relating to the localized resource has changed.

Returning to the printer example, the device 102 may send a series of messages 104 to the clients 106, reporting how many sheets of paper remain in its supply bin. Thus, each of these messages 104 may differ only in a parameter indicating the number of remaining sheets. However, in the message flow 400, each of these messages 104 could result in a respective iteration of the request 402 and the response 410, only to report a change in one parameter.

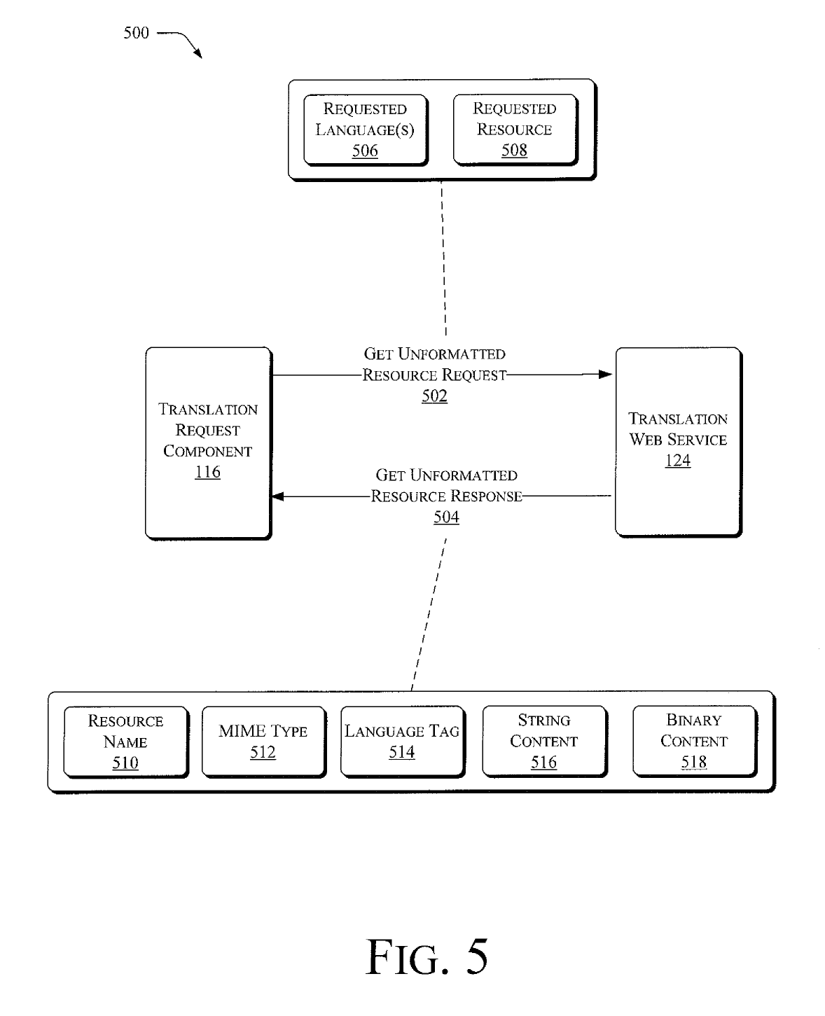

When a plurality of messages 104 correspond to different localizable resources 204, the message flow 400 may be suitable. When a sequence of messages 104 corresponds to the same localizable resources, but reports a change in parameter or state only, the message flow shown in FIG. 5 may be suitable.

It is noted that a given request 402 may request one or more localizable resources. Likewise, a given response 410 thereto may include one or more localizable resources. FIG. 4 shows a single instance of the resource names 406 and 412 only for clarify and convenience of illustration, and not to limit implementations of the subject matter described herein.

FIG. 5 illustrates an example message flow 500 by which the client 106 and/or the translation request component 116 may retrieve a localized resource corresponding to a received resource element 204. In the message flow 500, the client 106 submits a request 502 for an unformatted localized resource, and the translation web service 124 provides a response 504 containing an unformatted localized resource. This message flow 500 is now described in more detail.

The request 502 may include a field 506 that contains a language tag indicating the human-understandable language in which the unformatted localized resource is requested. Recall that FIG. 3 illustrates fields 306 containing language tags.

A field 508 may contain data representing a given resource supported by the translation web service 112. If the field 508 is blank for a particular request 502, then this may imply that all resources supported by the translation web service 112 are requested.

It is noted that since the request 502 is for an unformatted localized resource, the request 502 does not contain the parameter fields 408 shown in FIG. 4 for the request 402.

The following provides an example of an XML implementation of the request 502:

<tws:GetUnformattedResourceRequest>

[<tws:RequestedLanguages>

List of xs:string

</tws:RequestedLanguages>]?
[<tws:RequestedResources>

[<tws:Resource Name=xs:string />]+

</tws:RequestedResources>]*

</tws:GetUnformattedResourceResponse>

Turning now to the response 504, this response 504 may include a field 510 containing a name or other unique language-independent identifier for the provided localized resource. Recall that FIG. 2 illustrates fields 206 containing unique names or identifiers for various localizable resource elements.

A field 512 may contain a data type for the provided localized resource. For example, the field 512 may indicate a MIME type for the provided localized resource.

A field 514 may contain a language tag indicating the human-understandable language in which the unformatted localized resource is requested. Recall that FIG. 3 illustrates fields 306 containing language tags.

A field 516 may contain a string representing the localized version of the resource element 204, similar to the field 416 shown in FIG. 4. A field 518 may contain a binary representation of the localized version of the resource element 204, similar to the field 418 shown in FIG. 4.

The following provides an example of an XML implementation of the response 504:

<tws:GetUnformattedResourceResponse>

[<tws:UnformattedLocalizedResource Name=xs:strng
MimeType=xs:string>

[<tws:Content xml:Lang=xs:string>

[

<tws:StringContent>xs:string</
tws:StringContent>

|

<tws:BinaryContent>xs:base64Binary</
tws:BinaryContent>

]

</tws:Content>]+

</tws:UnformattedLocalizedResource>]÷

</tws:GetunformatedResourceResponse>

It is noted that a given request 502 may request one or more localizable resources. Likewise, a given response 504 thereto may include one or more localizable resources. FIG. 5 shows a single instance of the requested resource 508 and resource name 510 only for clarify and convenience of illustration, and not to limit implementations of the subject matter described herein.

Process Flows and Protocols

Having described the above message flows and related schemas, the discussion now turns to a description of example process flows or protocols by which the client 106 may obtain to formatted and unformatted versions of localized resources. FIG. 6 illustrates a flow for obtaining formatted versions of localized resources, while FIG. 7 illustrates a flow for obtaining unformatted versions of localized resources.

FIG. 6 illustrates a process flow 600 and related components by which the client 106 may obtain formatted versions of localized resources. The device 102 may send one or more language-independent messages 104 to the client 106.

The following provides an example of an XML implementation of the message 104. In this example, the message 104 takes the form of a printer reporting a paper jam:

<prn:PrinterStatus>

<prn:PrinterState>Error</prn:PrinterState>

<prn:PrinterStateReason>

<tws:Resource Name=“PaperJamWithLocation”
MimeType=“text”>

<tws:Param>3</tws:Param>

<tws:Resource>

</prn: PrinterStateReason>

</prn:PrinterStatus>

When the client 106 receives the messages 104, the client 106 can determine whether it is appropriate to present localized versions of the messages 104 to the user 108, via, for example, a suitable user interface (UI) 602. If so, the client 106 can request a localized version of the message 104 by submitting a request 402 to the translation web service 124.

The following provides an example of an XML implementation of the request 402. In this example, the client 106 requests English (US) and Afrikaans representations of the resource reported in the previous XML example:

<tws:GetResourceRequest>

<tws:RequestedLanguages>EN-US AF</tws:RequestedLanguages>
<tws:RequestedResources>

<tws:Resource Name=“PaperJamWithLocation”>

<tws:Param>3</tws:Param>

<tws:Resource>

</tws:RequestedResources>

</tws:GetResourceRequest>

After processing the request 402, the translation web service 124 provides a response 410, which may take the form of a localized resource provided in the human language specified in the request 402. Both the request 402 and the response 410 are described above with FIG. 4. It is noted that the translation web service 124 formats the response 402, rather than the client 106.

The following provides an example of an XML implementation of the response 402. In this response 402, the translation web service 124 performs formatting, and provides versions of the resource in the requested languages (English (US) and Afrikaans):

<tws:GetResourceResponse>

<tws:LocalizedResource Name=“PaperJamWithLocation”
MimeType=“text”>

<tws:Content xml:Lang=“EN-US”>Paper has jammed at
location 3.</tws:Content>
<tws:Content xml:Lang=“AF”>Papier voer problem in posisie
3.</tws:Content>

</tws:LocalizedResource>

</tws:GetResourceResponse>

The client 106 receives the response 402, and generates a formatted display 604 on the UI 602. In this manner, the user 108 may view a message corresponding to the localized resource, and take any appropriate action accordingly.

Having provided the above description of FIG. 6, several observations are noted. First, the client 106 may determine which incoming messages 104, if any, are to be converted into localized resources when such messages 104 arrive at the client 106.

Second, the client 106 need not specify a particular language to the translation web service 124 unless and until the client 106 submits a request 402 for a localized resource. Therefore, the translation web service 124 is not burdened with constantly storing and tracking language parameters for each of a plurality of different clients 106.

Additionally, the language may be specified for each such request 402 on a per-request basis. Therefore, as different users 108 become associated with a given client 106 over time, these different users 108 may have different language preferences. The client 106 may capture a language preference for the user 108 when that user 108 logs into, or otherwise becomes associated with, the client 106. Thus, when a given message 104 arrives at the client 106 at a given time, the client 106 can determines whether to obtain a localized resource for that message 104 at that time. Also, the client 106 can specify in the request the language preference for the particular user 108 who is associated with the client 106 at that given time. This capability relieves the client 106 from having to synchronize constantly with the translation web service 124 in terms of tracking the language preferences of the users 108.

FIG. 7 illustrates a process flow 700 and related components by which the client 106 may request and obtain unformatted versions of localized resources. As with FIG. 6 above, the device 102 may send one or more language-independent messages 104 to the client 106. If the client 106 determines to request a localized resource for the message 104, the client 106 may also evaluate whether to request a formatted localized resource (FIG. 6) or an unformatted localized resource, as described here with FIG. 7. To make this determination, the client 106 may reference a resource name or tag 206 contained in the message 104. The client 106 may also maintain state information related to various messages 104. Using this state information, the client 106 may determine whether a given message is reporting a new event, or is updating the state of a previously-reported event.

In this manner, the client 106 may determine whether the message 104 is likely to differ from previous messages 104 only in a value of a parameter. If so, the process flow 700 may be suitable. In this event, the client 106 may submit a request 502 for an unformatted localized resource to the translation web service 124.

The following provides an example of an XML implementation of the request 502. In this example, the client 106 does not include parameters in the request 502, and instead performs any formatting itself:

<tws:GetUnformattedResourceRequest>

<tws:RequestedLanguages>EN-US AF</tws:RequestedLanguages>
<tws:RequestedResources>

<tws:Resource Name=“PaperJamWithLocation” />

</tws:RequestedResources>

</tws:GetResourceResponse>

In turn, the translation web service 124 provides a response 504 to the request 502, both of which are discussed in FIG. 5 above. The response 504 is not formatted by the translation web service 124, but is instead formatted by the client 106. In but one possible implementation, a formatting component 702 may receive the response 504 and format it, for example, according to state information maintained by the client 106. The client 106 may then present a formatted display 604 on the UI 602 for the user 108.

The following provides an example of an XML implementation of the response 504:

<tws:GetUnformattedResourceResponse>

<tws:UnformattedLocalizedResource ResourceName=
“PaperJamWithLocation”

MimeType=“text”>

<tws:Content xml:Lang=“EN-US”>Paper has jammed at
location

{0}.</tws:Content>

<tws:Content xml:Lang=“AF”>Papier voer problem in posisie

{0}.</tws:Content>

</tws:UnformattedLocalizedResource>

</tws:GetUnformattedResourceResponse>

In the above example, the client 106 may format the response 504 by inserting a parameter or state information maintained by the client 106 in, for example, in the space between the curled brackets in the response 504 above.

### CONCLUSION

Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

Certain data structures are described herein in block form. It is understood that the block elements shown herein are shown and labeled only for convenience. Implementations of these data structures could include sub-sets or super-sets of the elements described and illustrated herein, and could include elements labeled or referenced differently than the elements herein, without departing from the spirit and scope of the description herein

In addition, regarding certain flow diagrams described and illustrated herein, it is noted that the processes and sub-processes depicted therein may be performed in orders other than those illustrated without departing from the spirit and scope of the description herein.

1. A system comprising:
at least one server adapted to receive at least one language-independent message containing at least one localizable resource element;
at least one client adapted to receive the message from the server, and to request a localized version of the resource element in a human-understandable language specified in the request; and
at least one translation web service adapted to receive the request, and to provide a response to the request including the localized version of the resource element.

2. The system of claim 1, wherein the client includes a translation request component adapted to request the localized version of the resource element.

3. The system of claim 1, wherein the server is adapted to provide the translation web service.

4. The system of claim 1, wherein the translation web service is adapted to receive requests for localized versions of resource elements from a plurality of clients.

5. The system of claim 1, further comprising at least a second client, and wherein the client is associated with a user having a preference for a first human language, and wherein the second client is associated with a second user having a preference for a second human language.

6. The system of claim 1, wherein the client includes a formatting component adapted to format the response to the request.

7. The system of claim 1, wherein the translation web service is adapted to format the response to the request.

8. A method executable at least in part by a computer-based system, the method comprising:
receiving a language-independent message containing at least one localizable resource element; and
requesting a localized version of the localizable resource element in a human-understandable language.

9. The method of claim 8, further comprising receiving the localized version of the localizable resource element.

10. The method of claim 8, wherein requesting a localized version of the localizable resource element includes requesting a formatted localized version.

11. The method of claim 8, wherein requesting a localized version of the localizable resource element includes requesting an unformatted localized version.

12. The method of claim 11, further comprising formatting the unformatted localized version of the resource element.

13. The method of claim 8, further comprising requesting a list of human languages in which versions of the localizable resource element may be provided.

14. A schema implementing, at least in part, the method of claim 8.

15. A method executable at least in part by a computer-based system, the method comprising:
receiving a request for a localized version of a localizable resource, wherein the request specifies a human-understandable language; and
providing the localized version in the human-understandable language in response to the request.

16. The method of claim 15, further comprising providing at least one resource element representing the localizable resource to at least one client.

17. The method of claim 15, further comprising providing data representing at least one supported human-understandable language supported to at least one client.

18. The method of claim 15, wherein providing the localized version includes providing a formatted localized version of the localizable resource.

19. The method of claim 15, wherein providing the localized version includes providing an unformatted localized version of the localizable resource.

20. A schema implementing, at least in part, the method of claim 17.
